(19) United States
(12) Patent Application Publication
(10) Pub. No.: US 2004/0194316 A1
(43) Pub. Date: Oct. 7, 2004

(54) Shaver having germ-killing device

(76) Inventors: Ray-Ming Lin, Shinjuang City (TW); Tzer-En Nee, Tao-Yuan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/407,575

(22) Filed: Apr. 4, 2003

(51) Int. Cl. B26B 19/00

(52) U.S. Cl. 30/34.05; 30/320; 30/43.4; 30/43.6

(57) ABSTRACT

A shaver includes a base portion with two shafts rotatably extending from a top surface of the base portion and each shaft has a blade unit mounted thereto. A plurality of light emitting members are located on the top surface of the base portion and around the at least one shaft. Each light emitting member emits a certain length of wave such as ultra violet ray toward the blade units so as to kill germs attached on the blade units.

### FIELD OF THE INVENTION

The present invention relates to a shaver that has several light emitting members which emit certain type of ray which kills germs attached on the blades of the shaver.

### BACKGROUND OF THE INVENTION

A conventional shaver is shown in FIG. 5 and generally includes a base portion 60 in which a motor is received and a switch is electrically connected to the motor. Two shafts 62 extend from a top of the base portion 60 so that two blade units 63 are respectively mounted to the two shafts 62. A cover 64 is mounted to the top of the base portion 60 and a small gap is defined between the netted portions of the cover 64 and the blade units 63. When activating the switch 61, the blade units 63 rotate to cut the portion of the mustache and/or beard that inserts into the netted portion. Although the blade units can be cleaned by water, very few users will clean the blade units. Therefore, there are germs attached onto the blade units and the germs could enter the body of the user if there is a cut wound in his or her skin.

The present invention intends to provide a shaver wherein the germs attached on the blade units can be killed by light emitting members located beside the blade units.

### SUMMARY OF THE INVENTION

In accordance with one aspect of the present invention, there is provided a shaver which comprises a base portion with at least one shaft rotatably extending from a top surface of the base portion and at least one blade unit is engaged with the at least one shaft. A plurality of light emitting members are located on the top surface of the base portion and around the at least one shaft. Each light emitting member emits a certain length of ray toward the at least one blade unit.

The primary object of the present invention is to provide a shaver that is equipped with light emitting members which emit ultra violet ray to kill germs on the blade units.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the shaver of the present invention;

FIG. 2 is a perspective view to show the shaver of the present invention;

FIG. 3 is a cross sectional view to show the shaver of the present invention;

FIG. 4 is an enlarged cross sectional view of the shaver of the present invention, and

FIG. 5 is an exploded view to show a conventional shaver.

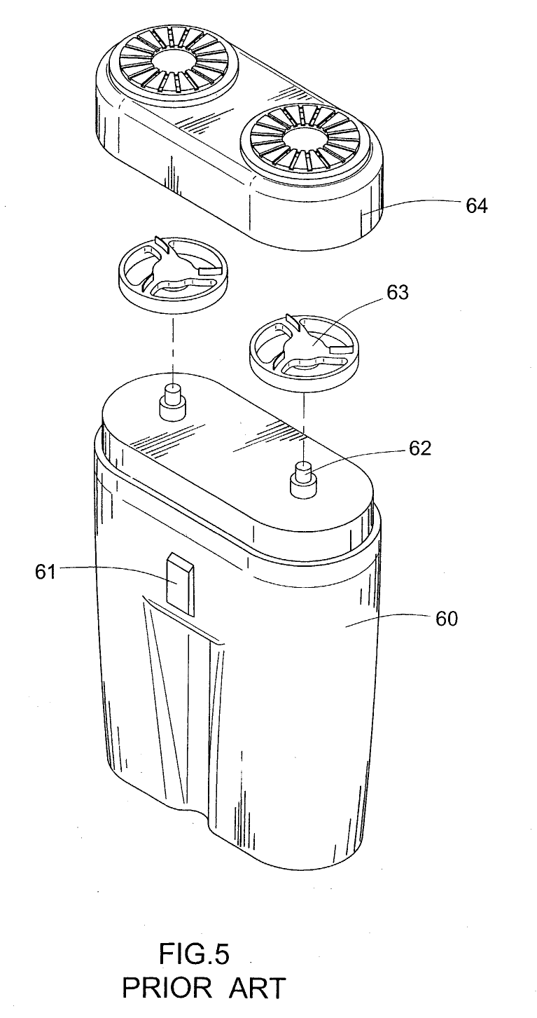

### DETAILED DESCRIPTION OF THE PREFERRED EMBODIMENT

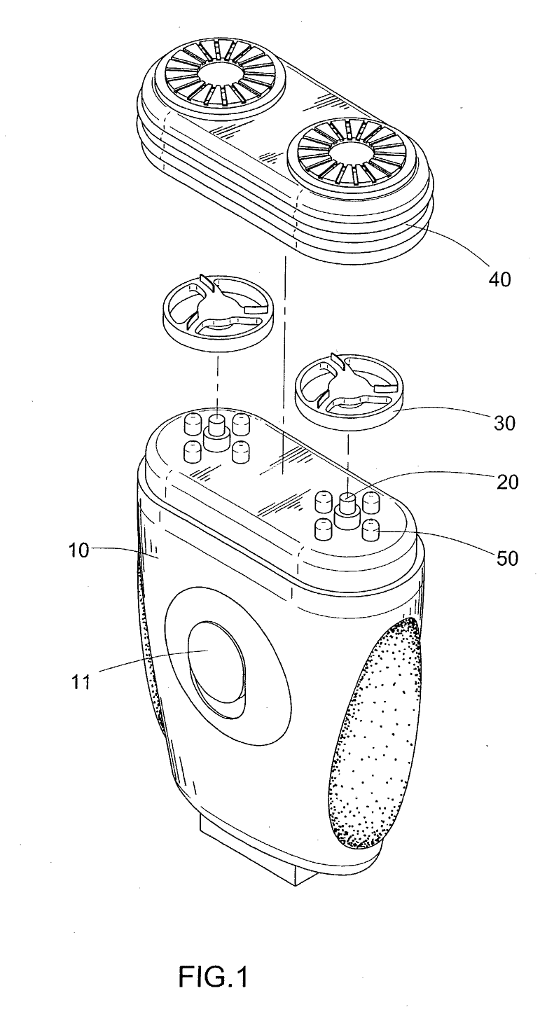

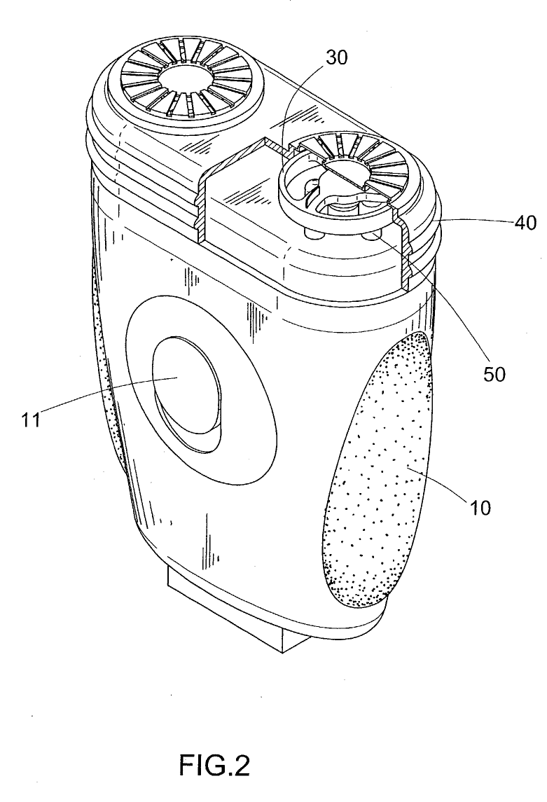

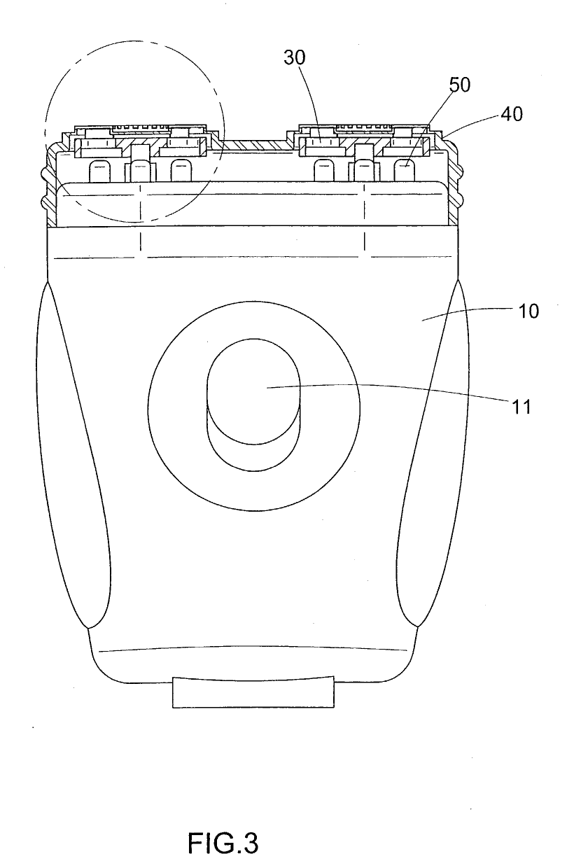

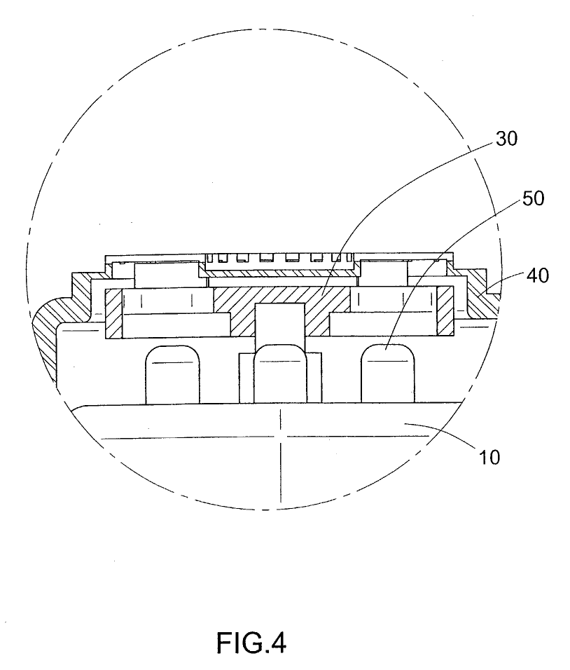

Referring to FIGS. 1 to 4, the shaver of the present invention comprises a base portion 10 in which a motor and a power supply device (both not shown) are installed. Two shafts 20 rotatably extend from a top surface of the base portion 10 and each shaft 20 has a blade unit 30 mounted thereto. A cover 40 with two netted portions is mounted to the top of the base portion 10 as the conventional shaver. A switch 11 is connected to an outside of the base portion 10 so as to activate the rotation of the shafts 20. A plurality of light emitting members 50 are located on the top surface of the base portion 10 and around the two shafts 20. Each light emitting member 50 emits a specific ray toward the blade units 30. The light emitting members 50 can be light diodes or laser diodes, and the ray that the light emitting members 50 emit can be emit ultra violet ray, visible ray or infra-red ray.

The light emitting members 50 are activated by operation the switch 11 so as to generate the ultra violet ray, for example, to kill the germs on the blade units 30 use, or the light emitting member 50 can be activated while the blade units 30 are not in use.

While we have shown and described the embodiment in accordance with the present invention, it should be clear to those skilled in the art that further embodiments may be made without departing from the scope of the present invention.

What is claimed is:

1. A shaver comprising:
a base portion with at least one shaft rotatably extending from a top surface of the base portion, a plurality of light emitting members located on the top surface of the base portion and around the at least one shaft, at least one blade unit engaged with the at least one shaft, each light emitting member emitting a certain ray toward the at least one blade unit.

2. The shaver as claimed in claim 1, wherein the light emitting members are light diodes.

3. The shaver as claimed in claim 1, wherein the light emitting members are laser diodes.

4. The shaver as claimed in claim 1, wherein the light emitting members emit ultra violet ray.
